(19) United States
(12) Patent Application Publication
(10) Pub. No.: US 2020/0122369 A1
(43) Pub. Date: Apr. 23, 2020

(54) Multi-step Method for Producing a Composite Component for Vehicles and Product Thus Obtained

(71) Applicant: SAPA S.p.A., NAPOLI (NA) (IT)

(72) Inventor: Antonio AFFINITA, NAPOLI (NA) (IT)

(21) Appl. No.: 16/483,532

(22) PCT Filed: Feb. 20, 2018
(86) PCT No.: PCT/IB2018/051024

§ 371 Date: Aug. 5, 2019

(30) Foreign Application Priority Data
Feb. 22, 2017 (IT) 102017000019746

(51) Int. Cl. B29C 45/16; B60R 13/08; F02B 77/13

(52) U.S. Cl. CPC B29C 45/1615; B29C 45/1676; B29C 2045/2689; F02B 77/13; B60R 13/0838

(57) ABSTRACT

A multi-step method for producing a composite component made of thermoplastic material and insulating foam, the method utilizing a multiple mold with a first cell and at least one second cell, provided with a male element and a female element, the cells taking a first closed configuration and a second open configuration; the method including: closing the multiple mold and, through a channel, injecting the thermoplastic material from a hot chamber to the first cell; solidifying the thermoplastic material and opening the multiple mold to move the solidified thermoplastic material from the first cell to the second cell; closing the multiple mold and, while a new injection occurs in the first cell, an insulating foam is injected into the second cell; opening the double mold and, while the finished product is extracted from the second cell, a new transfer occurs from the first cell.

### FIELD OF THE ART

The present invention operates in the field of mechanics and the automobile industry. More in detail the present invention regards a new and innovative process for producing the parts made of plastic material and foam of vehicles, due to a particular multiple mold and to the method of use thereof.

### PRIOR ART

The automobile industry is the branch of the manufacturing industry involved with the design, construction, marketing and sales of motor vehicles. After 2008 and 2009, when this was the industrial sector most hit by the economic and financial crisis, such field has since once again found momentum, with a growth greater than 25% in 2010. In 2011 nearly 80 million motor vehicles, which include cars and commercial vehicles, were produced throughout the world, making this the number one manufacturing field in the world for turnover.

This data suffices to explain the great variety of vehicles present on the market today; vehicles ranging from campers to commercial vans, utility vehicles and sports cars. However, all these vehicles—regardless of the purpose for which they were designed—today pursue the object of lowering pollutant emissions.

Indeed, most of the automobile industry research is now aimed to find solutions in order to respect international agreements and national laws on pollution, which provide for admissible CO₂ percentages that have been increasingly lower over the years. Such lowering of the emissions can be reached in two ways: the first is to optimize the operation of the engines which, at least at present, does not seem to give results sufficient for respecting regulations; the second is to reduce the weight of the vehicle and hence of each component thereof.

A first object of the present invention, in order to contribute to the reduction of the vehicle emissions, is that of producing plastic components for vehicles with thickness, and consequently also weight, considerably lower than that produced up to now.

More particularly, the reduction of thickness and weight reached by means of the present patent is applied to all those components which also require a foam portion that provides thermal and acoustic insulation.

A second object of the invention, described in detail hereinbelow, is that of optimizing the process for producing such components.

Currently, one proceeds by making the desired form of thermoplastic material, awaiting the time for cooling the material, typically about 3 minutes, proceeding with the injection of a foam that expands within a suitable mold and, finally, extracting the product from the second mold and finishing by eliminating the excess foam that flows out from the pre-established shape.

There are several international patents aimed for optimizing the production process for the various automobile components, such as the recent Chinese patent CN105689560 A. This describes a system of molds for producing the engine cover and the hood of a car but there are no references to the insulating parts made of foam or the like that constitute an integral and essential part of the industrial process.

Due to the present invention, all the steps currently necessary for producing the cover of the engine are unified and optimized, having as a result a much quicker and less expensive production process that uses a multiple mold, described hereinbelow.

### DESCRIPTION OF THE INVENTION

According to the present invention, a composite component for any one vehicle is made, provided with innovative characteristics and produced through a method which allows optimizing the industrial production.

Several non-limiting examples of the components that can be made, in an innovative and advantageous manner, due to the present invention, are the following: the kick plates, the central console, the under-engine guards, the door panels, the door gaskets, the central tunnel, the Esem control unit, etc.

Independent of the composite component made, in any case it is constituted by a shell made of thermoplastic material and at least by one insulating foam placed within said shell according to a configuration dependent on the type of component. The materials used are polyamide or polypropylene as thermoplastic material and a mixture of polyol, isocyanate and CO₂, commonly known with the name “pur”, as insulating foam. This selection of materials allows the advantage of considerably reducing the thickness of the component with respect to the currently known techniques.

Advantageously said foam can be suitably mixed in order to also be fireproof.

The present invention makes use of new and innovative machinery which advantageously allows the management of at least two simultaneous production cycles, considerably quickening the production.

The machinery consists of a multiple mold, provided with at least two cells, each of which provided with a male element and with a female element. Said cells are suitable to take, advantageously in a simultaneous and reversible manner, a first closed configuration or a second open configuration, depending on the current production step.

Advantageously, the first cell, at said female element, is provided with a channel which enables the introduction of the thermoplastic material stored in a hot chamber.

Advantageously, when said multiple mold is situated in said first closed configuration, the male elements and the female elements of each cell are configured for generating the interspaces having the shape of the shell made of thermoplastic material (first cell) and the shape of the thermoplastic material plus the insulating foam (second cell).

Said multi-step method requires at least four steps in order to create a finished product and it is developed as follows:
(A) Injection: in which said multiple mold is situated in said first closed configuration and, by means of said channel, a predetermined amount of thermoplastic material is injected into the interspace of said first cell.
(B) Transfer: in which, after the necessary time for cooling said thermoplastic material, said multiple mold is opened and the solidified thermoplastic material is moved from said first cell to said second cell.
(C) Foaming: in which said multiple mold is once again closed, and a predetermined amount of insulating foam is inserted into the second cell. Advantageously, in order to facilitate the expansion of the insulating foam, the configuration of said second cell is such that the solidified thermoplastic material is arranged with a tilt comprised between 20° and 60°, preferably 45°, with respect to the vertical. Simultaneously and advantageously, a new production cycle starts in said first cell by means of an injection step (A) as previously described.
(D) Extraction: in which, after a predetermined period of time starting from the end of said foaming step (C), said multiple mold is once again opened to extract the finished product and to carry out the transfer step (B) for the solidified thermoplastic material, result of the second production cycle underway.

Advantageously, said male element of said second cell can be provided with at least one punch, preferably metallic, adapted to contain the insulating foam during its expansion and solidification which occur during said foaming step (C).

Still in said foaming step (C), in an even more advantageous embodiment of the present invention, a predetermined amount of gas is introduced within the mixture of the insulating foam. This passage has the object of quickening the solidification of said insulating foam. More in detail, an analytical scale connected to a gas tank is adapted to release said predetermined amount of gas within the mixture of the insulating foam through an introduction channel regulated by a valve. The gas is preferably constituted by carbon dioxide CO₂ or, still more preferably, by nitrogen N₂.

Advantageously, in addition, said multi-step method for producing a soundproof composite component for internal combustion engines can comprise additional steps aimed to provide a more complex finished product according to a specific design. Said steps can consist of:
a step of spraying any one detaching material available on the market at least on the internal surfaces of said cells;
a step of inserting a solid flexible panel, preferably made of aluminum, suitable to serve as a heat shield or protection, between said transfer step (B) and said foaming step (C);
a step of inserting any one solid rotatable panel between said transfer step (B) and said foaming step (C). Said solid rotatable panel, advantageously, is preferably made of carbon or of any one plastic polymer and is connected to the surface of said solidified thermoplastic material through a common hinge system. Said solid rotatable panel, after the extraction (D) of the finished product, advantageously, is suitable to rotate around said hinge until it is superimposed on said solidified insulating foam, creating a sandwich-like structure within which the solidified insulating foam is situated;
a flaming step, between said transfer step (B) and said foaming step (C), which allows the perfect adherence between the solidified thermoplastic material and the insulating foam by activating the contact surface. It should be specified that this step has proven particularly useful if the thermoplastic material constituting the component is polypropylene.

In a more complex and advantageous embodiment, moreover, said multiple mold can be provided with one or more further cells, also provided with the corresponding male element and the corresponding female element, and these too being suitable to take, reversibly and simultaneously with the other cells, a first closed configuration and a second open configuration.

It is advantageously possible, moreover, to configure the multiple mold as is more convenient within the production plant, both for logistical and for production motives. In particular, the cells of the multiple mold can be stacked one on the other, one beside the other or mutually remotely positioned.

The advantages offered by the present invention are evident in light of the description described up to now and will be even clearer due to the enclosed figures and to the relative detailed description.

The production method, in a more general vision of the industrial process, advantageously enables a considerable reduction of the production costs, not requiring any post-production step to be carried out piece-by-piece by a specialized operator. Therefore, nearly all of the assembly operations and relative costs are eliminated, the internal movements of the product are eliminated and the components thus made are thinner and more durable than those produced with the known techniques.

### DESCRIPTION OF THE FIGURES

The invention will be described hereinbelow in at least one preferred embodiment, as a non-limiting example and with the aid of the enclosed figures in which:

FIGS. 1(a) and (b) show two three-dimensional views of a kick plate which falls within the possible composite components made according to the present invention.

FIGS. 2(a) and (b) respectively show a plan view and a three-dimensional view of an under-engine guard which falls within the possible composite components made according to the present invention.

FIG. 3 shows a three-dimensional view of a central console which falls within the possible composite components made according to the present invention.

FIG. 4 shows a three-dimensional view of a gear cover which falls within the possible composite components made according to the present invention.

FIG. 5 shows a three-dimensional view of an internal covering of an upright which falls within the possible composite components made according to the present invention.

FIG. 6 shows a three-dimensional view of an internal panel of a door which falls within the possible composite components made according to the present invention.

FIG. 7 shows the steps of production of any one of the composite components previously illustrated in FIGS. 1 to 6; in particular FIG. 7(a) shows the injection step A in which the multiple mold 100 is closed and the injection into the first cell 101 occurs; FIG. 7(a) shows the contact areas 101.c-102.c and the interspaces 101.d-102.d formed by the male element 101.a-102.a and by the female element 101.b-102.b of each cell 101-102; FIG. 7(b) shows the step B in which the multiple mold 100 is open and the element made of solidified thermoplastic material 201 is transferred to the second cell 102; FIG. 7(c) illustrates the foaming step C in which the insulating foam 300 is injected and made to expand in the interspace 102.d in the second cell 102, while a new injection step A starts in the first cell; FIG. 7(d), finally, shows a zoom on the male element 102.a of the second cell 102 from which the finished product is extracted (extraction step D). It is also possible to observe punches 130 in FIG. 7(d), which prevent the outflow of the insulating foam 300 before it becomes solidified insulating foam 301.

FIG. 8 schematically shows a particular embodiment of a possible component according to the present invention in which a sandwich-like structure is made with the solidified insulating foam 301 interposed between the solidified thermoplastic material 201 and a solid rotatable panel 250.

### DETAILED DESCRIPTION OF THE INVENTION

The present invention will now be illustrated as a merely non-limiting or non-constraining example, with reference to the figures which illustrate several embodiments relative to the present inventive concept.

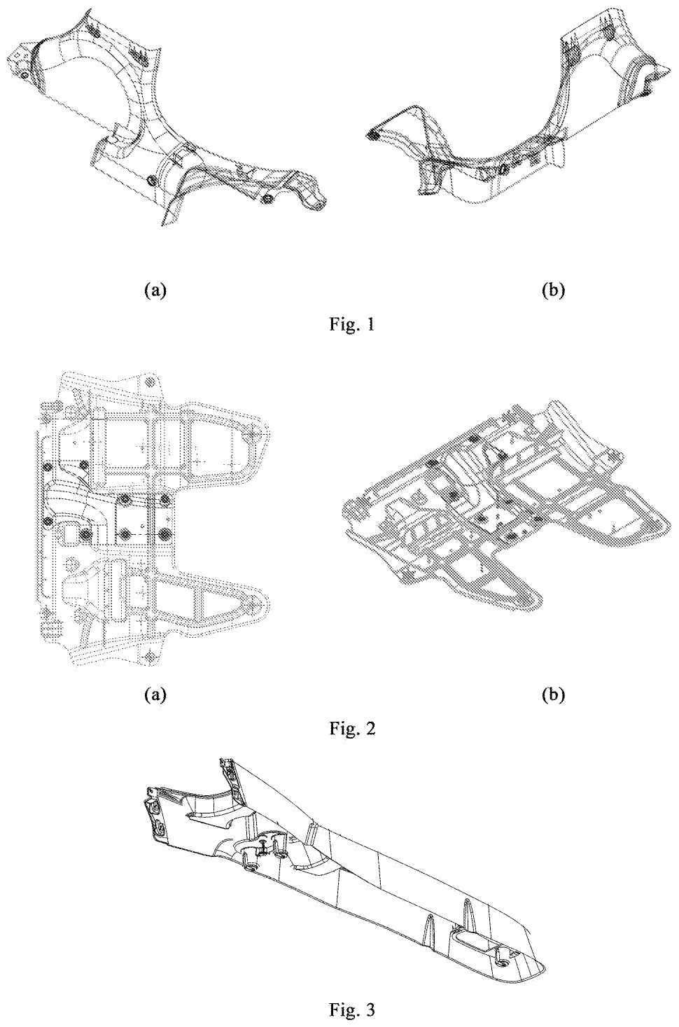

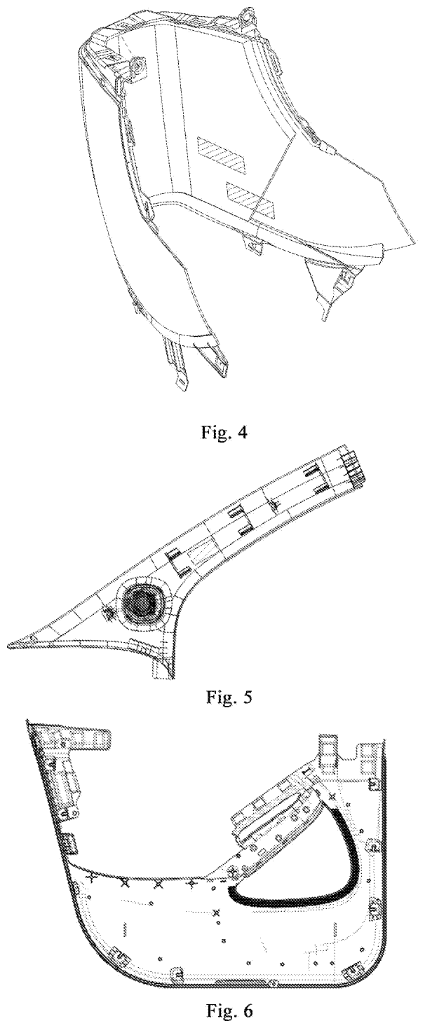

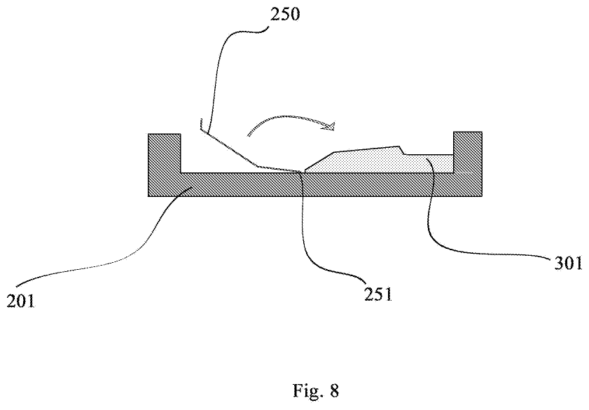

With reference to FIGS. 1 to 6, several of the components are shown which commonly constitute a vehicle; such components can be made by means of the method of the present invention. In any case, this is a component constituted by a rigid shell, made of solidified thermoplastic material 201, and by an underlying layer of insulation made of solidified insulating foam 301. Depending on the embodiment, the composite component can also be provided with any one solid flexible panel 150 which acts as heat shield or protection and/or with any one solid rotatable panel 250, schematically represented in FIG. 8, adapted to form a sandwich-like structure within which said solidified insulating foam 301 is arranged. Such solid rotatable panel 250 is preferably made of carbon fiber or any other plastic polymer and is fixed to the solidified thermoplastic material 201 through a common hinge 251.

Preferably, the materials used in making any composite component for a vehicle, object of the present invention, are: polypropylene or, still more preferably, polyamide as thermoplastic material 200 and the “pur” as insulating foam 300. The foam commonly known with the name “pur” is constituted by a suitably metered mixture of polyol, isocyanate and carbon dioxide.

In one possible embodiment, additionally, the insulating foam 200 also has fireproof function.

The selection of the abovementioned materials is given from the fact that, by means of their use and by means of the use of the production method described in detail hereinbelow, the thickness of the composite component can be considerably reduced with respect to that done up to now.

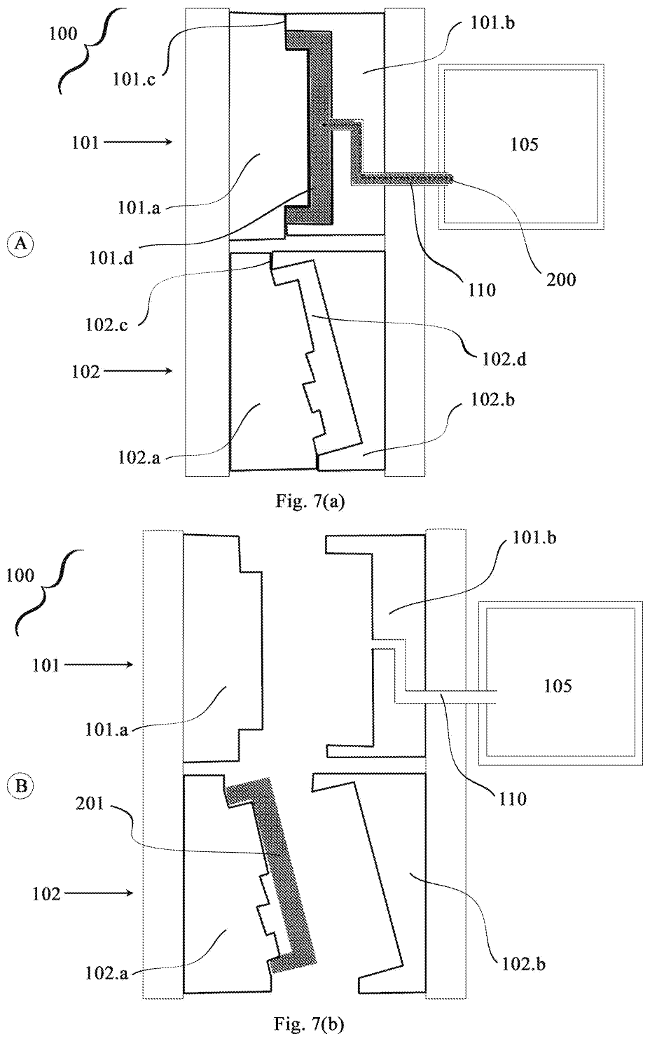

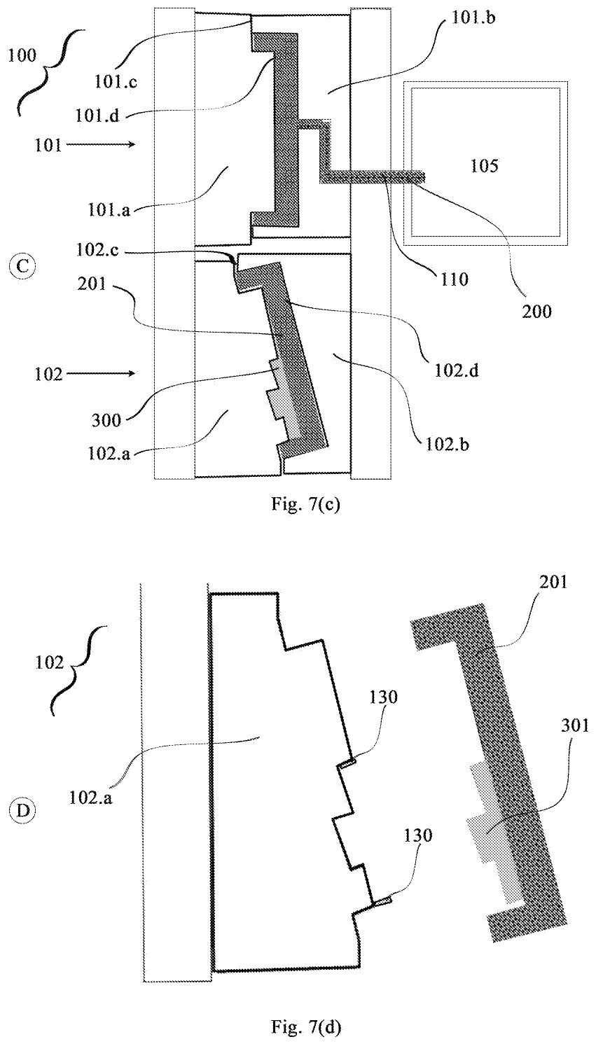

The production makes use of an innovative machinery, whose operation is illustrated in FIGS. 7(a), 7(b), 7(c) and 7(d), i.e. of a multiple mold 100. It is provided with a first cell 101 and with at least one second cell 102, each of which made up of a male element 101.a-102.a and a female element 101.b-102.b. In other embodiments it is possible to make a multiple mold 100, according to the present invention, provided with at least one further cell or with a plurality of further cells, also provided with a male element and with a female element with operation analogous to that described below.

Said multiple mold 100, depending on the production step in which it is situated, is adapted to take, in a reversible manner, a first closed configuration and a second open configuration. Said first closed configuration is characterized in that said male elements 101.a-102.a and said female elements 101.b-102.b are partially in contact with each other by means of the respective contact areas 101.c-102.c, respectively defining a first interspace 101.d suitable to be filled with the thermoplastic material 200 and a second interspace 102.d suitable to be filled with the solidified thermoplastic material 201 and with the insulating foam 300.

As an alternative to said first closed configuration, depending on the production step, said multiple mold 100 can reversibly take a second open configuration, characterized in that said male elements 101.a-102.a and said female elements 102.a-102.b of both said cells 101-102, are mutually spaced by a predetermined distance adapted to allow the extraction of the finished product from said multiple mold 100.

In other possible configurations of the present invention, not represented in the enclosed figures but in any case falling within the protective scope offered by the present patent, said cells 101, 102, . . . of said multiple mold 100 can be arranged in a vertically stacked configuration, in which the cells 101, 102, . . . are arranged one on the other, or in a lined up configuration, in which the cells 101, 102, . . . are arranged in horizontal sequence one beside the other, or in a configuration in which the cells 101, 102, . . . are mutually remotely positioned.

The multi-step method, object of the present invention, schematically depicted in FIGS. 7(a), 7(b), 7(c) and 7(d), is developed in cycles of at least four steps and, due to the above-described multiple mold 100, it is capable of managing at least two cycles simultaneously, with clear advantages in terms of production times and costs.

Said steps consist of:
(A) Injection step, in which said multiple mold 100 is situated in said first closed configuration and, by means of said channel 110 arranged at said female element 101.b of said first cell 101, a predetermined amount of thermoplastic material 200 is injected from the hot chamber 105 in which it is stored to said interspace 101.d of said first cell 101.
(B) Transfer step: in which, after a predetermined period of time, preferably 60 seconds, starting from the end of said injection step (A), said thermoplastic material 200 cools and becomes a solidified thermoplastic material 201; at this point, said multiple mold 100 takes said second open configuration and the solidified thermoplastic material 201 is extracted from said first cell 101 and arranged in said second cell 102. Such operation can be carried out by an assigned operator or in a mechanized manner
(C) Foaming step: in which said multiple mold 100 once again takes said closed configuration and, while a second production cycle initiates in said first cell 101, starting from the injection step (A), a predetermined amount of insulating foam 300 is injected into said second cell 102 in the interspace 102.d portion remaining between said solidified thermoplastic material 201 and said male element 102.a. It is observed that, in order to ensure a proper expansion and solidification of the insulating foam 300, it is necessary that said second cell 102 be configured in a manner such that the solidified thermoplastic material 201 is tilted, preferably at 45° or in any case with a tilt comprised between 20° and 60° with respect to the vertical axis. Possibly, during said foaming step C, an analytical scale connected to a gas tank is adapted to release a predetermined and stoichiometric amount of a specific gas within the mixture of the insulating foam 300 through an introduction channel regulated by a valve. The gas is preferably constituted by carbon dioxide CO₂ or, still more preferably, by nitrogen N₂. The presence of this gas allows quickening the solidification of the insulating foam 300. The time necessary for the solidification of the insulating foam 300, with the presence of said gas, could be reduced from 3 minutes to 1 minute, approximately.
(D) Extraction step: after a predetermined period of time starting from the end of said foaming step (C), said insulating foam 300 cools and becomes a solidified insulating foam 301; at this point, said multiple mold 100 once again takes said open configuration and, while the finished product or the composite component is extracted from said second cell 102, the solidified thermoplastic material 201 of the second production cycle is moved from said first cell 101 into said second cell 102 in a new transfer step (B).

With reference to FIG. 7(d), which consists of a more detailed view of the second cell 102 with respect to the preceding figures, it can be observed that, in the preferred embodiment of the multiple mold 100, said male element 102.a at least of said second cell 102 is provided with at least one punch 130, preferably metallic, so as to make the cell hermetic when said multiple mold 100 is situated in said first closed configuration, so as to contain the insulating foam 300 during its expansion and solidification, between said foaming step (C) and said extraction step (D).

Finally, based on the characteristics required by the specific composite component to be produced according to the present invention, additional steps can be inserted in the production cycle. One of these could be a step of spraying any one release agent at least on the internal surfaces of said cells 101-102. Such further step could be particularly useful if a sandwich-like structure is provided for the composite component (FIG. 8). Indeed, in this case the production method would also include a step, to be achieved between the transfer step (B) and the foaming step (C), in which a solid rotatable panel 250 is inserted, preferably made of carbon fiber or of any other plastic polymer and connected to the surface of said solidified thermoplastic material 201 through a common hinge system 251. Once the finished product has been obtained after said extraction step (D), in this case, said solid rotatable panel 250 is made to rotate around said hinge 251, by an assigned operator or in a mechanized manner, until it is superimposed on said solidified insulating foam 301, thus creating the desired sandwich-like structure.

Still in a possible additional step between the transfer step (B) and the foaming step (C), said solid flexible panel 150 can be inserted which is preferably made of aluminum and suitable to serve as a heat shield or protection (visible in FIG. 2).

Finally, if the thermoplastic material 200 is constituted by polypropylene, in some cases it could be useful and preferable to carry out a flaming step, between said transfer step (B) and said foaming step (C), which allows the perfect adherence between the solidified thermoplastic material 201 and the insulating foam 300 by activating the contact surface. Finally, it is clear that modifications, additions or variations that are obvious to the man skilled in the art can be made to the invention described up to now, without departing from the protective scope that is provided by the enclosed claims.

1. Multi-step method for producing a composite component for vehicles, suitable to produce a composite cover made of thermoplastic material (200) and insulating foam (300) with a predetermined shape so as to enable the complete covering and desired sound insulation of the aforementioned engine; said method utilizing a multiple mold (100) made up of a first cell (101), provided with a male element (101.a) and a female element (101.b), and at least one second cell (102), provided with a male element (102.a) and a female element (102.b), said first and said at least one second cell (101, 102) being suitable to take, in a simultaneous and reversible manner, a first closed configuration wherein said male elements (101.a, 102.a) and said female elements (101.b, 102.b) are partly in contact with each other, respectively through a first contact area (101.c) and a second contact area (102.c), so as to respectively define a first interspace (101.d) suitable to be filled with the thermoplastic material (200) and at least one second interspace (102.d) suitable to be filled with the solidified thermoplastic material (201) and with the insulating foam (300); said cells (101, 102) of said multiple mold (100) also being suitable to take, in a simultaneous and reversible manner, a second open configuration wherein said male elements (101.a, 102.a) and said female elements (101.b, 102.b) are mutually spaced to enable the extraction of the finished product; said method also being the method comprising:
A) Injection step: in said injection step (A) said multiple mold (100) is in said first closed configuration and, through a channel (110) arranged at said female element (101.b) of said first cell (101), a predetermined amount of thermoplastic material (200) is injected from a hot chamber (105) to said first interspace (101.d) of said first cell (101);
B) Transfer step: after a predetermined period of time starting from the end of said injection step (A), said thermoplastic material (200) cools and reaches the solid state so as to enable, in said transfer step (B), the opening of said multiple mold (100) in said second open configuration to extract the solidified thermoplastic material (201) from said first cell (101) and position it in said second interspace (102.d) of said second cell (102);
C) Foaming step: in said foaming step (C) said multiple mold (100) is closed and once again takes said first closed configuration and, while a new injection process (A) occurs in said first cell (101), a predetermined amount of insulating foam (300) is injected into said second cell (102) in the portion of interspace (102.d) present between said solidified thermoplastic material (201) and said male element (102.a), so that, by solidifying, said insulating foam (300) irreversibly adheres to the solidified thermoplastic material (201) with which it comes into contact;
D) Extraction step: after a predetermined period of time starting from the end of said foaming step (C), so as to enable the solidification of said insulating foam (300), said multiple mold (100) is opened and once again takes said second open configuration; in said extraction step (D), the finished product is extracted from said second cell (102), and simultaneously the solidified thermoplastic material (201) is extracted from said first cell (101) and arranged in said second cell (102) thus leading to a new transfer step (B).

2. Multi-step method for producing a composite component for vehicles, according to claim 1, wherein said multiple mold (100) is constituted by said first cell (101), provided with said male element (101.a) and said female element (101.b), by said second cell (102), provided with said male element (102.a) and with said female element (102.b), and by at least one further cell, provided with a further male element and with a further female element; said cells (101, 102, . . . ) being suitable to take, in a simultaneous and reversible manner, a first closed configuration in which said male elements (101.a, 102.a, . . . ) and said female elements (101.b, 102.b, . . . ) are partly in mutual contact, through the respective contact areas (101.c, 102.c, . . . ), so as to define respective interspaces (101.d, 102.d, . . . ) suitable to be filled with the thermoplastic material (200), with the insulating foam (300) and with further components of said composite component; said cells (101, 102, . . . ) of said multiple mold (100) also being suitable to take, in a simultaneous and reversible manner, a second open configuration wherein said male elements (101.a, 102.a, . . . ) and said female elements (101.b, 102.b, . . . ) are mutually spaced to enable the extraction of the finished product or finished products.

3. Multi-step method for producing a composite component for vehicles, according to claim 1, wherein, during said foaming step (C) a predetermined amount of a gas suitable to quicken the solidification of said insulating foam (300) is mixed with said insulating foam (300); said predetermined amount of said gas being controlled by a special pre-set analytical scale suitable to control the amount of said gas introduced into the mixture of said insulating foam (300).

4. Multi-step method for producing a composite component for vehicles, according to claim 1, wherein said second cell (102) has a tilt with respect to the vertical axis comprised between 20° and 60°.

5. Multi-step method for producing a composite component for vehicles, according to claim 1, wherein said male element (102.a) of said second cell (102) of said multiple mold (100) is provided with at least one punch (130) suitable to make said second cell (102) hermetic when said multiple mold (100) is in said first closed configuration, so as to contain the insulating foam (300) during the expansion thereof between said foaming step (C) and said extraction step (D).

6. Multi-step method for producing a composite component for vehicles, according to claim 1, wherein said cells (101, 102, . . . ) of said multiple mold (100) can be arranged in a vertically stacked configuration, wherein the cells (101, 102, . . . ) are arranged one on the other, or in a lined up configuration, wherein the cells (101, 102, . . . ) are arranged in horizontal sequence, one beside the other, or in a configuration wherein the cells (101, 102, . . . ) are mutually remotely positioned.

7. Multi-step method for producing a composite component for vehicles, according to claim 1, further comprising at least one step of spraying any one detaching material available on the market, on the inner surfaces of said cells (101, 102), so as to facilitate the detachment of the solidified thermoplastic material (201) and the finished product respectively from said first cell (101) and from said second cell (102).

8. Multi-step method for producing a composite component for vehicles, according to claim 1, comprising a further step of inserting any one solid flexible panel (150), arranged in direct contact with the solidified thermoplastic material (201), between said transfer step (B) and said foaming step (C); said solid flexible panel (150) being suitable to serve as a heat shield or protection.

9. Multi-step method for producing a composite component for vehicles, according to claim 1, further comprising a step of inserting any solid rotatable panel (250) between said transfer step (B) and said foaming step (C); said solid rotatable panel (250), after said step (D) of extracting the finished product, being suitable to rotate around said hinge (251) until it is superimposed on said solidified insulating foam (301), thus creating a sandwich-like structure within which said solidified insulating foam (301) is found.

10. Multi-step method for producing a composite component for vehicles, according to claim 1, further comprising a flaming step between said transfer step (B) and said foaming step (C); said flaming step being suitable to enable the adherence between said solidified thermoplastic material (201) and said insulating foam (300) by activating the contact surface.

11. Composite component for vehicles, comprising a thermoplastic material (200) constituted by polypropylene and a polyurethane foam constituted by a mixture of polyol, isocyanate and carbon dioxide, commonly referred to as “pur”.

12. Composite component for vehicles, according to the preceding claim 11, wherein said insulating foam (300) is fireproof.

13. Composite component for vehicles, according to claim 11, wherein at least one portion is covered with a solid flexible panel (150), suitable to serve as heat shield or protection.

14. Composite component for vehicles, according to claim 11, further comprising a solid rotatable panel (250), connected to the surface of the solidified thermoplastic material (201) through a common hinge system (251); said solid rotatable panel (250) being suitable to rotate around said hinge (251) until it is superimposed on said solidified insulating foam (301), thus creating a sandwich-like structure within which said solidified insulating foam (301) is found.

15. A part in the form of a kick plate, an under-engine guard, an internal panel of a door, a door gasket, a center console, a gear cover, or a control unit, wherein the component comprises the composite component of claim 11.

16. Multi-step method for producing a composite component for vehicles, according to claim 1, wherein, during said foaming step (C) a predetermined amount of carbon dioxide (CO₂) suitable to quicken the solidification of said insulating foam (300) is mixed with said insulating foam (300); said predetermined amount of said gas being controlled by a special pre-set analytical scale suitable to control the amount of said gas introduced into the mixture of said insulating foam (300).

17. Multi-step method for producing a composite component for vehicles, according to claim 1, wherein, during said foaming step (C) a predetermined amount of nitrogen (N₂) suitable to quicken the solidification of said insulating foam (300) is mixed with said insulating foam (300); said predetermined amount of said gas being controlled by a special pre-set analytical scale suitable to control the amount of said gas introduced into the mixture of said insulating foam (300).

18. Multi-step method for producing a composite component for vehicles, according to claim 1, wherein said second cell (102) has a tilt with respect to the vertical axis of 45°.

19. Multi-step method for producing a composite component for vehicles, according to claim 1, wherein said male element (102.a) of said second cell (102) of said multiple mold (100) is provided with at least one metallic punch (130) suitable to make said second cell (102) hermetic when said multiple mold (100) is in said first closed configuration, so as to contain the insulating foam (300) during the expansion thereof between said foaming step (C) and said extraction step (D).

20. Multi-step method for producing a composite component for vehicles, according to claim 1, comprising a further step of inserting any one solid flexible aluminum panel (150), arranged in direct contact with the solidified thermoplastic material (201), between said transfer step (B) and said foaming step (C); said solid flexible panel (150) being suitable to serve as a heat shield or protection.
